(19) United States
(12) Patent Application Publication
(10) Pub. No.: US 2018/0293504 A1
(43) Pub. Date: Oct. 11, 2018

(54) DEVICES, METHODS, AND SYSTEMS FOR DETERMINING ENVIRONMENTAL STANDARD COMPLIANCE

(71) Applicant: Honeywell International Inc., Morris Plains, NJ (US)

(72) Inventors: Jayaprakash Meruva, Bangalore (IN); John Boothroyd, North Ryde (AU); Daming Fu, Beijing (CN); Hao Chen, Beijing (CN)

(21) Appl. No.: 15/941,833

(22) Filed: Mar. 30, 2018

Related U.S. Application Data
(60) Provisional application No. 62/480,038, filed on Mar. 31, 2017.

(51) Int. Cl. G06N 5/04; G01D 1/18

(52) U.S. Cl. CPC G06N 5/04; G01D 1/18

(57) ABSTRACT

Devices, methods, and systems for determining environmental standard compliance are described herein. One computing device for determining environmental standard compliance includes one or more sensors for measuring at least one environmental parameter to be used in calculating whether a facility system is in compliance with an environmental standard, a memory to store data values received from the sensor and historical data values of the at least one parameter and instructions executable by the processor. The processor configured to execute the executable instructions stored in the memory to access multiple data values regarding thresholds to be met under a particular environmental standard or a particular facility in order to maintain compliance, access historical data values to be compared with the multiple data values regarding thresholds to determine historical compliance with the environmental standard, access current data values to be compared with the multiple data values regarding thresholds for multiple standard parameters to determine historical compliance with the environmental standard, and determine compliance with the environmental standard based on comparison of the historical and current data values with the multiple data values regarding thresholds to determine whether each of the multiple standard parameters is met and the facility is in compliance with the standard.

### PRIORITY INFORMATION

This application is a Non-Provisional of U.S. Provisional Application No. 62/480,038, filed Mar. 31, 2017, the contents of which are incorporated herein by reference.

### TECHNICAL FIELD

The present disclosure relates to devices, methods, and systems for determining environmental standard compliance.

### BACKGROUND

In recent years, several countries have been working toward a greener and more sustainable future and as such, companies have been working toward designing and creating a greater percentage of buildings that are certified as green and sustainable. However, with different countries coming out with their own standards of certification and the evaluation methodology, the factors/parameters that are used in these standards of certification vary based, for example, on their country's unique geographical characteristics, such as: environmental conditions, politics and legislation, industrial sectors, and/or socio-economic structures.

A few preeminent environmental standards have emerged and are followed in several countries. For example, Leadership in Energy and Environmental Design (LEED) for the United States, Building Research Establishment Environmental Assessment Method (BREEAM) for the United Kingdom and Green Star for Australia are the most accepted and common global rating systems in the current sustainable building industry. NABERS, the National Australian Built Environment Rating System, is another rating system from the government of Australia to measure and compare the environmental performance of Australian buildings. This rating system differs a bit from the aforementioned certification systems, as they focus primarily on grading how the building performs after its been completed instead of during its initial design and creation. They offer a comprehensive set of rating tools that work well in determining the sustainability levels of a building over a period of time.

Though LEED, BREEAM, Green Star, and NABERS schemes are similar in aims and approach, their rating methodology varies considerably, in terms of measurement of building performance, scope, and environmental criteria within the infrastructure sector. With regard to building assessment, they vary according to different weightings and categories.

For example, with respect to NABERS indoor environmental rating, it requires data like the area of your office premises in square meters, geographical location, temperature data including the temperature range, air speed (m/s), relative humidity (RH), carbon dioxide levels, carbon monoxide levels, etc. For use with water rating, it requires twelve months of water consumption data and for energy rating, it requires twelve months of energy consumption data (i.e., bills for electricity, gas, diesel, etc.), the number of computers in the facility, and hours of occupancy of the facility.

Overall certification requires several factors in which certain parameters like annual consumption of energy or trending of indoor air quality, etc., have to be measured continuously/regularly to produce sustainable evidence to certification body when evaluating for re-accreditation. Currently, the data that is required for a certification body is collected manually and supplied to the rating organization at a time much later than when it was collected. The environmental standards organizations then use rating system calculators and feed these details along with all other factors into these calculators to analyze and determine the sustainability level of a building.

This manual collection of data can take significant labor effort and also can leads to manual errors. There have, for example, been incidents where the collected data is not given the weighting required for certification calculations and, therefore, the building is not maintained as expected and, subsequently, the sustainable control mechanisms are degraded over a period of time.

### BRIEF DESCRIPTION OF THE DRAWINGS

FIG. 1 illustrates an example of a method for determining environmental standard compliance in accordance with one or more embodiments of the present disclosure.

FIG. 2 illustrates an example of a computing device for determining environmental standard compliance in accordance with one or more embodiments of the present disclosure.

### DETAILED DESCRIPTION

As discussed above, the present disclosure relates to devices, methods, and systems for determining environmental standard compliance. In order for a facility to continue to be certified under some standards, data regarding some parameters of these standards needs to be verified.

In embodiments of the present disclosure, this information can be obtained from sensor data received from sensors connected to a computing device. For example, one or more computing device embodiments for determining environmental standard compliance can include one or more sensors for measuring at least one environmental parameter to be used in calculating whether a facility system is in compliance with an environmental standard.

As described below, the embodiments can include memory to store data values received from the one or more sensors and historical data values of the at least one parameter and instructions executable by the processor of a computing device. Historical data values can include, for example, sensor data taken at an earlier period of time and stored in memory (minutes, weeks, months, or years earlier) or information that is necessary for certification that has not changed since the last time the certification was obtained (e.g., building materials used, amount of recycled materials used, etc.).

The processor can be configured to execute the executable instructions stored in the memory to have the computing device perform tasks, such as initiate data collection by the one or more sensors or analyze the data values collected or stored in memory. For example, in some embodiments, the processor can execute instructions to access multiple data values regarding thresholds to be met under a particular environmental standard or a particular facility in order to maintain compliance.

The compliance standard threshold values are compared with an aggregate total sensor data value wherein multiple sensor data values are combined to indicate a total sensor data value for a particular criterion of the compliance standard. For example, regression equations (e.g., average, sum, etc.) can receive data from multiple sensors, and the output of such an equation can be compared to a compliance standard threshold value.

For instance, to calculate overall water consumption there will be several water flow sensors across a facility and all the data from these sensors is collected continuously and summed to arrive at an overall water consumption over a particular period of time. Thresholds, as used herein, can be maximum or minimum threshold values that, when a sensor's data value is outside of the threshold, a facility is non-compliant with the parameter that is being measured by the sensors collecting data for that criterion of the compliance standard. For example, if the parameter is water consumption and the consumption volume value is over the threshold value, then the facility would not be in compliance based on the water consumption parameter.

As discussed above, in some embodiments, historical data values can be accessed so that they can be compared with the multiple data values regarding thresholds. This can be done to determine historical compliance with the environmental standard. Further, some certifications for standards require at least 12 months of data to show continued compliance and/or a trend for the data values in order to pass the certification. In such methodologies, the historical data values are needed for present certification, not just to verify historical compliance.

In some embodiments, current data values can be access in addition to or alternatively to historical data values such that they can be compared with the multiple data values regarding thresholds for multiple standard parameters to determine compliance with the environmental standard. As used herein, current data values are values that are the most recently received data values that are received in real-time or shortly before the present moment in time. For example, a current data value may have been received within the last day from the present time. In some embodiments, the current data value may have been received within the last minute of the present time. In various embodiments, the one or more sensors may push sensor data values to a computing device that is determining environmental compliance. In some embodiments, the computing device, via executable instructions stored in memory, initiates a request to the sensor to provide sensor data values to the computing device. In both cases, these most current data values would be considered to have been received in real-time.

As discussed herein, these current data values can be used to determine compliance with an environmental standard. For instance, some embodiments can also determine compliance with the environmental standard based on comparison of the historical and current data values with the multiple data values regarding thresholds to determine whether each of the multiple standard parameters is met and the facility is in compliance with the standard.

Embodiments of the present disclosure can evaluate compliance with a particular standard and/or track compliance based on logging of data values over a period of time. Embodiments can provide real-time analysis of compliance with an environmental standard and can alert a user if one or more parameters of the standard are not being met or a trending toward non-compliance.

It should be noted that although one or more parameters may be non-compliant, depending upon the methodology of the standard the facility may not be non-compliant with the standard as a whole. For example, in LEED, parameters are given point values and therefore, it may be the case that although a facility may have lost points during recertification due to non-compliance of a particular parameter, the facility may still have enough points to allow for recertification.

This may be particularly true in methodologies where parameters are weighted differently. In such embodiments, if a parameter has a minimal weight versus other certification parameters and the facility is non-compliant, it may not matter with regard to recertification, if the other parameters allow for recertification without the lowly weighted parameter that is non-compliant.

Some embodiments, can be configured to collect respective sensors (e.g., actuators, energy meters, etc.) data from a building control system and these factors can be calculated automatically without human intervention, via executable instructions stored in memory. In such embodiments, the results of such standards analytics, can allow for the data to be produced as one or more dashboards and any deviations to a set target of consumption (which can be set by the user via the user interface) can be raised as an alert to building owners or other users. These dashboards and/or alerts can, for example, be stored and accessed through a web portal at any point in time by a user and can also be pushed to user's mobile device, to alert them even when not viewing the dashboard on a laptop or desktop device.

In another embodiment, in case of a NABERS energy rating for data centers, NABERS considers IT equipment's processing and storage capacity on servers, storage, and networking devices to measure energy efficiency in delivering support services to the IT equipment. In this example, the data values are collected from IT systems and then evaluated for certification.

This type of automatic system for certification enables the facility to be continuously monitored to make sure it adheres to the particular standards applicable to the facility and also will enable building owners to take appropriate actions when the parameters are beginning to deviate from set values or are nearing a threshold value. Such embodiments also reduce last minute surprises during the recertification time frame.

Embodiments of the present disclosure can also be used to evaluate smart facility systems where a rating system (Smart Building Score) is used to calculate building smartness, for example, based on lighting, HVAC, and/or energy usage of smart devices for access, safety, security, and/or other systems within the facility.

The devices, systems, and methods of the present disclosure for determining environmental compliance and providing the benefits described above, among others, are discussed in more detail below with respect to the examples provided by the figures. In the following detailed description, reference is made to the accompanying drawings that form a part hereof. The drawings show by way of illustration how one or more embodiments of the disclosure may be practiced.

These embodiments are described in sufficient detail to enable those of ordinary skill in the art to practice one or more embodiments of this disclosure. It is to be understood that other embodiments may be utilized and that mechanical, electrical, and/or process changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

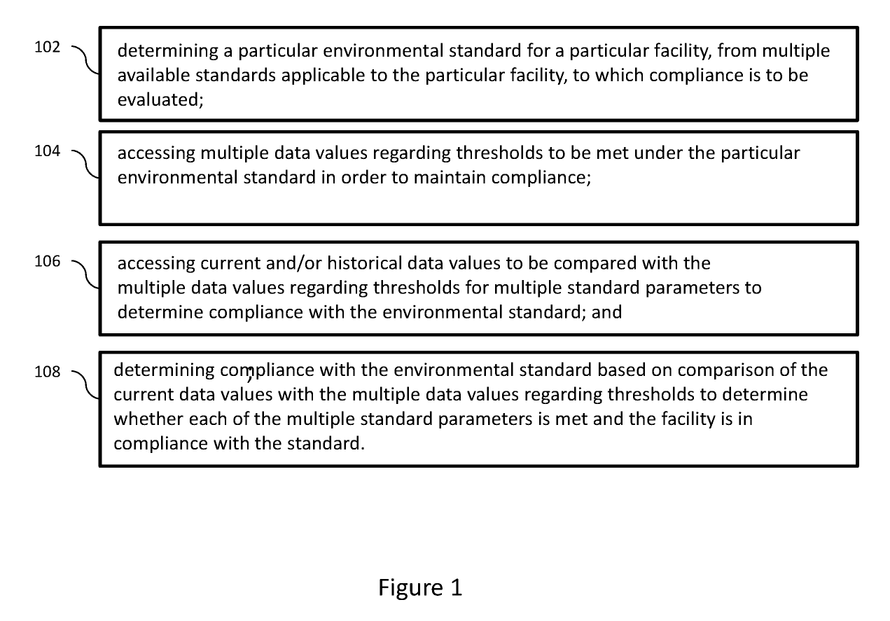

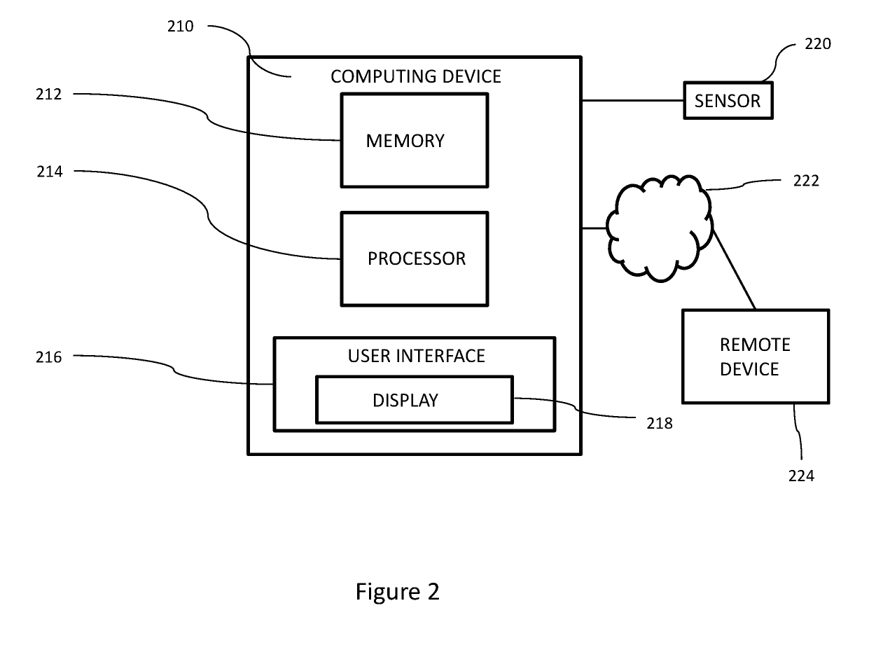

The figures herein follow a numbering convention in which the first digit or digits correspond to the drawing figure number and the remaining digits identify an element or component in the drawing. Similar elements or components between different figures may be identified by the use of similar digits. For example, 118 may reference element “18” in FIG. 1, and a similar element may be referenced as 218 in FIG. 2.

As used herein, “a” or “a number of” something can refer to one or more such things, while “a plurality of” something can refer to more than one such things. For example, “a number of components” can refer to one or more components, while “a plurality of components” can refer to more than one component.

FIG. 1 illustrates an example of a method for determining environmental standard compliance in accordance with one or more embodiments of the present disclosure. In the embodiment illustrated in FIG. 1, the method includes determining a particular environmental standard for a particular facility, from multiple available standards applicable to the particular facility, to which compliance is to be evaluated, at block 102.

In this example, the particular environmental standard can be selected by a user via a user interface (as will be described in more detail below with respect to FIG. 2). For instance, a user could select LEED certification from a list of possible certifications that the building has either received or is capable of receiving.

For example, the list may contain all environmental standards available worldwide and the user could select from the list, the particular one that the facility is being recertified for. In some embodiments, the list may only include standards for the country in which the facility resides. And, in a third example, the list may contain only those standards that the facility has received certification.

At block 104, the method includes accessing multiple data values regarding thresholds to be met under the particular environmental standard in order to maintain compliance. In this element, the thresholds for meeting the parameters of the standard are defined. This provides the framework to determine whether the facility will be in compliance.

The embodiment also includes accessing current data values to be compared with the multiple data values regarding thresholds for multiple standard parameters to determine compliance with the environmental standard, at block 106. In this element, the current data values, as described above, are compared to the thresholds and if the data value for a parameter is outside of a particular threshold for a parameter, then the facility is not in compliance for that parameter of the standard.

At block 108, the method includes determining compliance with the environmental standard based on comparison of the current data values with the multiple data values regarding thresholds to determine whether each of the multiple standard parameters is met and the facility is in compliance with the standard.

With respect to determining compliance with the standard as a whole, the multiple standard parameters described above may be only those that will result in recertification. For example, in a methodology where points are used, if there are parameters where their point value is not going to change the outcome of certification, then they may not be included in the “multiple standard parameters” described above. However, in some embodiments, all possible parameters, may constitute the “multiple standard parameters” described above.

In various embodiments, the multiple standard parameters can, for example, be selected from the group including: water flow, water consumption, energy consumption, oil consumption, and fuel consumption. Multiple standard parameters can also, for example, either alternatively or additionally, be selected from the group including: hours of occupancy, net lettable area, number of computing devices, and type of fuel.

Although these are two examples of types of parameters that may be considered, any standard that needs to be monitored for compliance would be suitable for use as a parameter in the embodiments of the present disclosure. Other types of parameters can, for example, include lighting, indoor air quality, safety systems, security systems, and performance data. The data values for these parameters can be received, for example, from on premise control panels and/or integrated building management system, among other facility devices and systems.

In some embodiments, rather than receiving data values directly from the one or more sensors, the data values may be received indirectly from other resources. For example, data values may be received from a building management system associated with the facility. In such an embodiment, the building management system may initiate the data collection by the one or more sensors or the building management system may store received data values in memory until such information is requested for purposes of determining environmental standard compliance. In such embodiments the data may be received directly from the building management system associated with the facility or communicated indirectly via a distributed control network.

A facility, as used herein, can be and/or include a building such as, for instance, a commercial office building, a shopping complex, or an airport, and can be located remotely from the computing device performing the determination of compliance. However, embodiments of the present disclosure are not limited to a particular type of facility.

FIG. 2 illustrates an example of a computing device for determining environmental standard compliance in accordance with one or more embodiments of the present disclosure. In the embodiment of FIG. 2, computing device 210 can be, for example, located at the facility or remotely located away from the facility.

Computing device 210 can be, for example, a laptop computer, a desktop computer, or a mobile device (e.g., smart phone, tablet, PDA, wearable device, etc.). However, embodiments of the present disclosure are not limited to a particular type of computing device.

As shown in FIG. 2, computing device 210 can include a memory 212 and a processor 214. Memory 212 can be any type of storage medium that can be accessed by processor 214 to store data and/or perform various examples of the present disclosure.

For example, memory 212 can be a non-transitory computer readable medium having computer readable instructions (e.g., computer program instructions) stored thereon that are executable by processor 214 to perform a determination of environmental standard compliance in accordance with the present disclosure. That is, processor 214 can execute the executable instructions stored in memory 212 to determine environmental standard compliance in accordance with the present disclosure.

Memory 212 can be volatile or nonvolatile memory. Memory 212 can also be removable (e.g., portable) memory, or non-removable (e.g., internal) memory. For example, memory 212 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disk read-only memory (CD-ROM)), flash memory, a laser disk, a digital versatile disk (DVD) or other optical disk storage, and/or a magnetic medium such as magnetic cassettes, tapes, or disks, among other types of memory.

Further, although memory 212 is illustrated as being located in computing device 210, embodiments of the present disclosure are not so limited. For example, memory 212 can also be located internal to another computing resource (e.g., enabling computer readable instructions to be downloaded over the Internet or another wired or wireless connection), such as remote device 224, for example, and accessible via connection 222, which can be a wired or wireless connection.

As shown in FIG. 2, computing device 210 can include a user interface 216. A user (e.g., operator) of computing device 210, such as, for instance, an operator, manager, and/or technician of a building management system, can interact with computing device 210 via user interface 216. Further, user interface 216 can receive information from (e.g., input by) the user of computing device 210.

In some embodiments, user interface 216 can be a graphical user interface (GUI) that can include a display 218 (e.g., a screen) that can provide and/or receive information to and/or from the user of computing device 210. The display can be, for instance, a touch-screen (e.g., the GUI can include touch-screen capabilities). As an additional example, user interface 216 can include a keyboard and/or mouse the user can use to input information into computing device 210. Embodiments of the present disclosure, however, are not limited to a particular type(s) of user interface.

In some embodiments, the connection 222 can be a network connection. In such embodiments, the network 222 can be a wired or wireless network.

Examples of such a network relationship can include a distributed computing environment (e.g., a cloud computing environment), a wide area network (WAN) such as the Internet, a local area network (LAN), a personal area network (PAN), a campus area network (CAN), or metropolitan area network (MAN), among other types of network relationships. For instance, the network can include a number of servers that receive the data collected by BMS data collector 112 and transmit the received data to fault detection server 116 via a wired or wireless network.

As used herein, a “network” can provide a communication system that directly or indirectly links two or more computers and/or peripheral devices and allows users to access resources on other computing devices and exchange messages with other users. A network can allow users to share resources on their own systems with other network users and to access information on centrally located systems or on systems that are located at remote locations. For example, a network can tie a number of computing devices together to form a distributed control network (e.g., cloud).

In such a cloud environment, the compliance standard evaluation tools may be located on a cloud server and a remote device may be used to send data to the cloud server. In addition, the same or a different remote computing device can be used by a user to access the tools, initiate a compliance evaluation, and submit compliance to standards organizations.

In some embodiments, the compliance standard evaluation tools may be accessible by a user via an app located on a mobile phone which may have all of the resources necessary to complete a compliance evaluation or may communicate to a computing device have information or tools available thereon to accomplish the compliance evaluation. In various embodiments, the compliance standard evaluation tools may be accessible via a web portal which may be provided on a remote device.

A network may provide connections to the Internet and/or to the networks of other entities (e.g., organizations, institutions, etc.). Users may interact with network-enabled software applications to make a network request, such as to get a file or print on a network printer. Applications may also communicate with network management software, which can interact with network hardware to transmit information between devices on the network.

In one example embodiment, a computing device 210 for determination of environmental standard compliance based on historical and current sensor data values includes one or more sensors 220. The sensors 220 can be used for measuring at least one environmental parameter (e.g., fuel consumption) to be used in calculating whether a facility system is in compliance with an environmental standard.

The embodiment also includes memory 212 to store data values received from the sensor and historical data values of the at least one parameter and instructions executable by the processor 214 which is configured to execute the executable instructions stored in the memory 212. The execution of such instructions can be used to access multiple data values regarding thresholds to be met under a particular environmental standard or a particular facility in order to maintain compliance. The executable instructions can also be used to access historical data values to be compared with the multiple data values regarding thresholds to determine compliance with the environmental standard. Further, instructions can be executed to access current data values to be compared with the multiple data values regarding thresholds for multiple standard parameters to determine compliance with the environmental standard. The embodiment can be utilized to determine compliance with the environmental standard based on comparison of the historical and current data values with the multiple data values regarding thresholds to determine whether each of the multiple standard parameters is met and the facility is in compliance with the standard.

In some embodiments, the facility is selected by a user. This can be accomplished, for example via a map showing the facility thereon that is displayed on a computing device display 218. The map can, for example, be a two dimensional or three dimensional geographical, building information system map, or other facility map where the facility can be selected from one or more facilities on illustrated on the map.

In some embodiments, the display can include a dashboard displayed on a display 218 of a computing device 210 wherein the dashboard includes a visualization of the current data values compared to a threshold data value for a particular parameter to assist a user in determining if the facility is in compliance for that parameter of the particular environmental standard. For example, the visualization can be in the form of a graph or chart or can be similar to an engine rev. meter of an automobile where the threshold can be viewed as analogous to the redline on the rev. meter.

Instructions can also be provided to be executable by the processor to provide a dashboard displayed on a display of a computing device wherein the dashboard includes a visualization of the historical and current data values compared to threshold data values for a particular standard parameter over a period of time to assist a user in determining if the facility is trending toward becoming in non-compliance for that parameter of the particular environmental standard. Alternatively, or additionally, instructions can be executable by the processor to provide a dashboard displayed on a display of a computing device wherein the dashboard includes a visualization of the historical and current data values compared to threshold data values for multiple parameters over a period of time to assist a user in determining if the facility is trending toward becoming in non-compliance for one or more of the displayed parameters of the particular environmental standard. These embodiments can be beneficial, for example, in enabling a user to be able to potentially reverse and issue with the facility before the facility or a parameter reaches a threshold constituting non-compliance.

In various embodiments, the memory can have more information stored in it than just the information for one facility with respect to one standard. For example, the memory may have data values and historical data stored for multiple facilities and/or for multiple environmental standards.

In such embodiments, the memory can include historical and current data values for evaluating compliance of multiple environmental standards and particular data value categories (water consumption, which may contain several water consumption parameters within the category) are selected based upon the determination of the particular environmental standard selected. In this manner, data values can be selected that will be useful in making a determination of compliance based on the one or more data categories selected.

In some embodiments, the computing device can track compliance with the environmental standard over a period of time and determine when the particular facility is out of compliance. For example, as data values are collected, the analysis for determining compliance can be done several times over a period of time and each analysis can make the determination based on the data values received at that time.

For example, the processor can be configured to execute the instructions to track compliance with the environmental standard over a period of time and determine when at least one parameter of the standard is out of compliance for the particular facility. In some embodiments, the processor is configured to execute the instructions to track compliance of at least one parameter of the environmental standard over a period of time and determine when the at least one parameter being tracked is out of compliance for the particular facility.

Further, in some embodiments, the data values can be evaluated to indicate trends in the data which can be used to diagnose whether the facility is maintaining its compliance status or whether the facility is heading toward non-compliance. For example, if the water consumption data values are analyzed over a period of six months and the water consumption data values are increasing toward a threshold at which the facility is no longer compliant based on the water consumption parameter, the trend may be able to be reversed before the threshold is reached.

In some such embodiments, the processor 214 is configured to execute the instructions to alert a user (e.g., via the user interface 216) that the facility is out of compliance or to alert a user that the facility is nearing non-compliance based on at least one parameter.

Another example embodiment includes a non-transitory computer readable medium 212 having computer readable instructions stored thereon that are executable by a processor 214. These instructions are executable to determine a particular facility, from multiple available facilities, that is to be evaluated for compliance with the environmental standard. This can be accomplished, for example, by selection by a user via the user interface 216. This can also, for example, be accomplished via a user selection or can be selected based upon a time period for recertification or via executable instructions.

The instructions can also be executed to determine a particular environmental standard, from multiple available standards, to which compliance is to be evaluated. This can also, for example, be accomplished via a user selection or can be selected based upon a time period for recertification or via executable instructions.

Executable instructions can also be provided to access multiple data values regarding thresholds to be met under the particular environmental standard in order to maintain compliance. As discussed above, this allows the determination of compliance to be determined as will be discussed in more detail below.

Instructions can also be provided to access historical data values and/or current data values to be compared with the multiple data values regarding thresholds to determine compliance with the environmental standard. Further, instructions can be provided to determine compliance with the environmental standard based on comparison of the historical and current data values with the multiple data values regarding thresholds to determine whether each of the multiple standard parameters is met and the facility is in compliance with the standard.

In some embodiments, instructions are executable by the processor to store 12 months of data values for at least one standard parameter and then upon collection of the 12 months of data, the determination of whether the facility is in compliance with the particular environmental standard is initiated.

For example; in case of NABERS water rating, the certification body requires 12 months of water consumption to determine a trend. Similarly, for energy ratings, 12 months of electricity, gas, fuel bills, and their consumption trends for heating and cooling the building, for indoor environmental rating, and trending of CO2 and CO levels in the facility, temperature set point deviations, etc. are needed.

Instructions can also be provided to determine a facility profile that defines a number of standard parameters to be tracked and determines a calculation method for performing the determination of compliance with the particular environmental standard. For example, some environmental standards are specific as to their methodology with respect to their calculation method for determining compliance.

Instructions can be provided to determine which calculation method to utilize. This can be accomplished, for example, based on the selection of a particular environmental standard and a geographical location of the facility, wherein the geographical location is determinative as to which methodology to utilize (e.g., temperature, humidity, or other environmental condition may play a role in the calculation).

In some embodiments, the instructions are executable by the processor to initiate the collection of real-time sensor data values from the sensors and use the real-time sensor data values in the determination of compliance with the particular environmental standard. In such embodiments, the analysis of compliance can be accomplished in a very timely manner with respect to the current compliance of the facility. This can be beneficial where data collection used to span over a long period and therefore inaccuracies could occur where a parameter had become non-compliant, but the sensor data that was provided was aged.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A computing device for automatic calculation of environmental standard compliance based on historical and current sensor data values, comprising:
one or more sensors for measuring at least one environmental parameter to be used in calculating whether a facility system is in compliance with an environmental standard;
a memory to store data values received from the sensor and historical data values of the at least one parameter and instructions executable by the processor; and
a processor configured to execute the executable instructions stored in the memory to:
access multiple data values regarding thresholds to be met under a particular environmental standard or a particular facility in order to maintain compliance;
access historical data values to be compared with the multiple data values regarding thresholds to determine historical compliance with the environmental standard;
access current data values to be compared with the multiple data values regarding thresholds for multiple standard parameters to determine historical compliance with the environmental standard; and
determine compliance with the environmental standard based on comparison of the historical and current data values with the multiple data values regarding thresholds to determine whether each of the multiple standard parameters is met and the facility is in compliance with the standard.

2. The computing device of claim 1, wherein the data values stored in memory include historical and current data values for evaluating compliance of multiple environmental standards and wherein particular data value categories are selected based upon the determination of the particular environmental standard selected.

3. The computing device of claim 1, wherein the processor is configured to execute the instructions to track compliance with the environmental standard over a period of time and determine when the particular facility is out of compliance.

4. The computing device of claim 3, wherein the processor is configured to execute the instructions to alert a user that the facility is out of compliance.

5. The computing device of claim 3, wherein the processor is configured to execute the instructions to alert a user that the facility is nearing non-compliance based on at least one parameter.

6. The computing device of claim 1, wherein the processor is configured to execute the instructions to track compliance with the environmental standard over a period of time and determine when at least one parameter of the standard is out of compliance for the particular facility.

7. The computing device of claim 1, wherein the processor is configured to execute the instructions to track compliance of at least one parameter of the environmental standard over a period of time and determine when the at least one parameter being tracked is out of compliance for the particular facility.

8. A method for determining current compliance with an environmental standard, comprising:
determining a particular environmental standard for a particular facility, from multiple available standards applicable to the particular facility, to which compliance is to be evaluated;
accessing multiple data values regarding thresholds to be met under the particular environmental standard in order to maintain compliance;
accessing current data values to be compared with the multiple data values regarding thresholds for multiple standard parameters to determine compliance with the environmental standard; and
determining compliance with the environmental standard based on comparison of the current data values with the multiple data values regarding thresholds to determine whether each of the multiple standard parameters is met and the facility is in compliance with the standard.

9. The method of claim 8, wherein the method includes receiving data values from a building management system associated with the facility.

10. The method of claim 9, wherein the method includes receiving the data from the building management system associated with the facility via a distributed control network.

11. The method of claim 8, wherein the facility is selected by a user via a map showing the facility thereon that is displayed on a computing device display.

12. The method of claim 8, wherein the multiple standard parameters are selected from the group including: water flow, water consumption, energy consumption, oil consumption, and fuel consumption.

13. The method of claim 8, wherein the multiple standard parameters are selected from the group including: hours of occupancy, net lettable area, number of computing devices, and type of fuel.

14. A non-transitory computer readable medium having computer readable instructions stored thereon that are executable by a processor to:
determine a particular facility, from multiple available facilities, that is to be evaluated for compliance with the environmental standard;
determine a particular environmental standard, from multiple available standards, to which compliance is to be evaluated;
access multiple data values regarding thresholds to be met under the particular environmental standard in order to maintain compliance;
access historical data values to be compared with the multiple data values regarding thresholds to determine historical compliance with the environmental standard;
access current data values to be compared with the multiple data values regarding thresholds for multiple standard parameters to determine historical compliance with the environmental standard; and
determine compliance with the environmental standard based on comparison of the historical and current data values with the multiple data values regarding thresholds to determine whether each of the multiple standard parameters is met and the facility is in compliance with the standard.

15. The computer readable medium of claim 14, wherein the instructions are executable by the processor to store 12 months of data values for at least one standard parameter and then upon collection of the 12 months of data, the initiation of a determination of whether the facility is in compliance with the particular environmental standard.

16. The computer readable medium of claim 14, wherein the instructions are executable by the processor to determine a facility profile that defines a number of standard parameters to be tracked and determines a calculation method for performing the determination of compliance with the particular environmental standard.

17. The computer readable medium of claim 15, wherein the instructions are executable by the processor to initiate the collection of real-time sensor data values from the sensors and use the real-time sensor data values in the determination of compliance with the particular environmental standard.

18. The computer readable medium of claim 15, wherein the instructions are executable by the processor to provide a dashboard displayed on a display of a computing device wherein the dashboard includes a visualization of the current data values compared to a threshold data value for a particular parameter to assist a user in determining if the facility is in compliance for that parameter of the particular environmental standard.

19. The computer readable medium of claim 15, wherein the instructions are executable by the processor to provide a dashboard displayed on a display of a computing device wherein the dashboard includes a visualization of the historical and current data values compared to threshold data values for a particular standard parameter over a period of time to assist a user in determining if the facility is trending toward becoming in non-compliance for that parameter of the particular environmental standard.

20. The computer readable medium of claim 15, wherein the instructions are executable by the processor to provide a dashboard displayed on a display of a computing device wherein the dashboard includes a visualization of the historical and current data values compared to threshold data values for multiple parameters over a period of time to assist a user in determining if the facility is trending toward becoming in non-compliance for one or more of the displayed parameters of the particular environmental standard.
